(19) United States
(12) Patent Application Publication
(10) Pub. No.: US 2009/0222363 A1
(43) Pub. Date: Sep. 3, 2009

(54) Systems And Methods For Automated Retail Recovery Auditing

(76) Inventors: James B. Arnold, Greensboro, NC (US); Christopher Scott Lewis, Greensboro, NC (US); Philip McRay Beane, JR., Greensboro, NC (US)

Correspondence Address: KILPATRICK STOCKTON LLP, 1001 WEST FOURTH STREET, WINSTON-SALEM, NC, 27101, US

(21) Appl. No.: 12/094,437

(22) PCT Filed: Dec. 18, 2006
(86) PCT No.: PCT/US2006/048172

§ 371 Date: Aug. 27, 2008

Related U.S. Application Data
(60) Provisional application No. 60/750,927, filed on Dec. 16, 2005.

(51) Int. Cl. G06Q 10/00; G06F 17/30

(52) U.S. Cl. 705/30; 707/3; 707/E17.014; 707/E17.044

(57) ABSTRACT

Systems and methods for automated recovery auditing are described. In one described system, an analytical engine receives deal information. The analytical engine then receives purchase order information associated with the deal information. If any discrepancies are identified, the analytical engine generates a notification identifying the discrepancy.

### CROSS-REFERENCE TO RELATED APPLICATIONS

This application claims priority to U.S. Provisional Patent Application No. 60/750,927, filed Dec. 16, 2005, entitled “Systems And Methods For Automated Retail Recovery Auditing”, the entirety of which is hereby incorporated by reference.

### FIELD OF THE INVENTION

This invention relates generally to systems and methods for account reconciliation. More particularly, embodiments of this invention relate to systems and methods for automated retail recovery auditing.

### BACKGROUND OF THE INVENTION

Retailers perform recovery audits to identify situations in which a retailer has paid more than an agreed to amount for a product. These situations may be referred to as exceptions. These exceptions are then presented as a chargeback or reduction to a vendor. Historically, the retailer would hire a primary auditor who would identify a certain amount of these exceptions. The retailer would then hire a secondary auditor who would find additional exceptions, generally a fewer number than what the primary auditor uncovered. The primary and secondary auditors are conventionally paid a percentage of what they identify, typically at a lower rate for the primary auditor and a somewhat higher rate for the secondary. For instance, a primary auditor may retain 25% of the dollar amount for exceptions identified and the secondary auditor may retain 35%. This is due to the additional amount of work the secondary auditor has to perform to identify each exception, i.e., the secondary auditor has to dig deeper and harder. At some point in time, a retailer may decide that it should be able to identify some of these exceptions internally and will establish an internal group to perform the audits in addition to the primary and secondary auditors.

The retailer may utilize a semi-automated method for identifying exceptions. For instance, the retailer may extract data from the various relevant information systems and attempt to tie the data together to identify exceptions. However, in each case, the auditor, whether internal, primary, or secondary, is performing the recovery audit on a historical basis. Typically, the audit is performed at least three months after the fact and may occur as late as eighteen or even thirty-six months after a transaction occurs.

The current situation in retail regarding chargebacks and deductions is an unhealthy one, often leading to an adversarial relationship between the retailer and their vendors. With multiple recovery audits (internal/primary/secondary) being conducted anywhere from six months to three years after the original transaction, the corresponding deductions cause hard feelings and financial pressures for both retailers and vendors. Retailers may feel that they have been potentially “cheated” out of monies due to them when lost funds are identified long after the original transaction, and vendors feel as though the rules of the promotion are being stretched way beyond their intended purposes, impacting fiscal years that have long since been closed out.

From the retailers' perspective, if there are promotional monies that they are rightfully entitled to, these monies should be pursued. This is even more compelling given the generally low margins of retailers and their growing responsibilities toward their shareholders, spurred by the Sarbanes-Oxley environment and the well-publicized financial failures of retail organizations. Even if the funds are ultimately retrieved, there is a lost use of cash that could have been reinvested in the business. Further, for many retailers, the audit recoveries are budgeted for and often represent a disproportionate share of their expected “profit” for the year.

From the vendors' perspective, promotional guidelines, time frames and performance requirements are put in place for a reason, to achieve the profitable movement of product through the retail distribution channel. Promotional monies are budgeted for at a detailed level and are intended to impact revenues and profits in the current fiscal period. When deductions are taken months or years after the fact, it may be difficult to reliably predict company performance. In addition, when deductions or chargebacks are submitted well after a transaction takes place, the vendor may incur substantial labor cost, the inability to automate cash application since the deductions appear at random, and a lack of timely feedback. Further, information about a particular transaction may be difficult to determine. For example, the sales person who made commitments at the original transaction may long since be gone.

Unfortunately, recovery audit firms are incented primarily by recoveries, so there is a significant degree of “throwing things up against the wall to see if they will stick.” Many vendors give up, not because they believe the deductions are legitimate, but because the retrieval of funds will further strain limited resources and potentially damage the relationship with the retailer.

Recovery auditing has existed within the retail industry for nearly forty years. This “results only” business model has delivered billions of dollars in increased profits for large retailers, and has led to substantial improvements in their internal control environments.

Despite these successes, the approach falls far short of a solution. The retrieval of lost funds still requires significant internal labor, a level of disruption to the organization, the loss of float on the overpayments, collection issues with suppliers, the payment of significant fees to contingency auditors, and creates an adversarial relationship between manufacturers and retailers. While effective, recovery auditing can be a highly inefficient delivery mechanism for error handling. Further, at some point, an organization wants to provide the correct the problems that are leading to recoveries.

### SUMMARY

Embodiments of this invention provide systems and methods for automated recovery auditing. In one embodiment, an analytical engine receives deal information. The analytical engine then receives purchase order information associated with the deal information. If any discrepancies are identified, the analytical engine generates a notification identifying the discrepancy. In another embodiment, a computer-readable medium (such as, for example random access memory or a computer disk) comprises code for carrying out such a process.

These illustrative embodiments are mentioned not to limit or define the invention, but to provide examples to aid understanding thereof. Illustrative embodiments are discussed in the Detailed Description, and further description of the invention is provided there. Advantages offered by the various embodiments of this invention may be further understood by examining this specification.

### FIGURES

These and other features, aspects, and advantages of the this invention are better understood when the following Detailed Description is read with reference to the accompanying drawings, wherein:

FIG. 1 is a block diagram of an illustrative environment for implementation of an embodiment of this invention;

FIG. 2 is a flowchart illustrating a process an analytical engine may use to identify inconsistencies in one embodiment of this invention;

FIG. 3 is a flowchart illustrating a process for deal identification in one embodiment of this invention;

FIG. 4 is a screen shot of a screen for displaying an off-invoice summary in one embodiment of this invention;

FIG. 5 is a screen shot of a screen for displaying off-invoice detail in one embodiment of this invention;

FIG. 6 is a screen shot of an item master inquiry screen in one embodiment of this invention; and

FIG. 7 is a screen shot of a receiving inquiry screen in on embodiment of this invention

### DETAILED DESCRIPTION

Embodiments of this invention provide systems and methods for automated recovery auditing.

### Illustrative Automated Recovery Auditing

In one illustrative embodiment of this invention, a system provides a distributor or retailer (referred to herein as “retailer”) with automated deal discovery, exception identification, and deal resolution. In one embodiment, a retail solution provides lost profits in real-time, but is not burdened by the heavy labor, long cycle time and excessive costs of the current audit process. In one such embodiment, complex deal algorithms are codified at the point of deal issuance to the retailer, retained in a comprehensive contract repository, and applied to all purchase orders at the point of order creation.

Any discrepancies between the purchase orders and the codified deal sheets are immediately quantified and sent to the buyer via email notification. These notifications trigger immediate action by the buyer, and enable him/her to resolve issues at the order creation point rather than months or years later as with conventional systems. The information about discrepancies impacts buying decisions in real-time, improving retail buyer performance without subjecting manufacturers to unpredictable financial impacts long after accounting periods are closed out.

Within retail, such an embodiment provides an automated approach that can be expanded far beyond just overpayment prevention. Using the Web, vendor self-service is delivered 24/7/365 to assist vendors with cash application without manual assistance. Dispute resolution is provided as well by taking advantage of simple reporting and document imaging technologies. Also, retailers more effectively track their earned accrual funds into a “bank account” and advise the manufacturer as these funds are deployed to support their promotional efforts. It is a very compelling value proposition for both manufacturers as well as their customers in retail.

One such embodiment utilizes an exception processor, which implements a set of processes for taking data, analyzing it for inconsistencies and providing exceptions in a simple and understandable format. These exception reports are generated on a daily basis and sent to either buyers or account payable (A/P) analysts for review.

The exception processor may use data from a retailer's existing systems and match recent purchases to contract terms, flagging those purchases that did not get the contract price to which the retailer was entitled. This exception processing logic is designed to be flexible and to allow the retailer to specify how they want to match deals to purchases. Flexibility is advantageous in this matching process as many retailers may identify their allowances and deal references in different ways within their purchase orders.

Such an embodiment may also include the ability for the system to identify trends in purchasing and to use this information in identifying exceptions that may warrant further investigation. As data is loaded, the system examines the data to identify averages and highs and lows in item pricing and flags situations where purchase order pricing is substantially different from the identified trends. These may be referred to as loose exceptions. The retailer may or may not pursue these once they are identified.

Once the system identifies an exception, the system generates reports and notifications that are sent to the individuals responsible for researching the exception further. In one embodiment, the reporting module is designed as a web application, and exception reports are available online for retrieval. Some embodiments of this invention provide deep reporting on exceptions over time. In some embodiments, the system may also automatically send certain exceptions to an accounting system as a credit or adjustment. Such an embodiment provides a retailer with the ability to detect and prevent an error or to detect and recover from an error within a few days instead of months as with conventional systems and methods.

One embodiment of the present invention also includes an online dispute resolution component. In such an embodiment, retailers provide exceptions have been identified as true claims to vendors, and the vendors react to the claims online. Vendors are able to interact with buyers and A/P analysts regarding disputes through the Internet or some other communication means and to provide feedback on how to resolve the claims soon after the exceptions have been identified.

These examples are given to introduce the reader to the general subject matter discussed. The invention is not limited to these examples. Further illustrative features and embodiments are described below.

### System Description

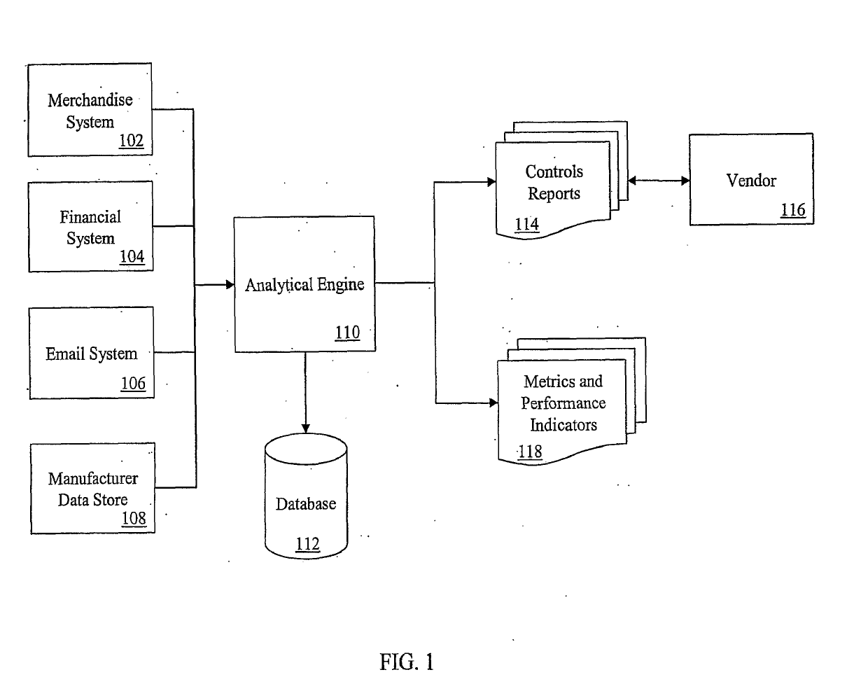

FIG. 1 is a block diagram of an illustrative environment for implementation of an embodiment of this invention. In the embodiment shown, an organization accesses data in various information systems and from other data sources, both internal and external. The information systems include a merchandise system 102. The merchandise system 102 may include, for example, point-of-sale data, an item master, purchase orders, receipts, and invoices.

The information systems also include a financial system 104. The financial system 104 may include, for example, accounts receivable information, chargebacks, and inventory information. While the merchandise system 102 and financial system 104 are shown as two separate systems, they may be a part of a single integrated system or may comprise a plurality of individual systems. The embodiment shown in FIG. 1 is merely illustrative.

The organization also includes one or more information systems for storing and/or collecting deal information. These deal collection systems include an email system 106. Often an organization will employ one or more buyers. The buyers may correspond with suppliers via email. The details of various purchases may be captured in these emails but not otherwise stored. In the embodiment shown in FIG. 1, these emails serve as a source of deal information and can be mined. For example, a computer algorithm may search an email server for all emails include certain keywords, such as “discount” or “volume,” and flag those emails as potentially containing deal information. Deal information can then be extracted from the flagged emails automatically or manually. Deal information may also be keyed into the system manually from paper deal information.

The embodiment shown in FIG. 1 also includes a manufacturer data store 108. The manufacturer data store 108 may include information such as deal information uploaded from a manufacturer's information systems. For instance, a manufacturer may provide a file containing current deal information on a nightly basis.

An analytical engine 110 receives data from each of the information systems 102-108. The analytical engine 110 uses this data to identify to identify chargebacks and possible reductions. The analytical engine 110 may comprise the exception processor as described above. The chargebacks and reductions are a result of deal information that is not accurately reflected in the invoices presented by the manufacturer or in the payments made by the organization. For example, a manufacturer may agree to provide a ten percent price reduction for a purchase of greater than a specified quantity. However, the invoice may not reflect the discount and thus, the organization has paid more than the amount that is agreed to.

If the discrepancy occurs after payment of the invoice, the organization prepares a chargeback for submission to the manufacturer. If the organization identifies the discrepancy before paying the invoice, the organization can apply a discount to the invoice.

The analytical engine 110 includes a processor (not shown). The processor comprises a computer-readable medium, such as a random access memory (RAM) (not shown) coupled to the processor. The processor executes computer-executable program instructions stored in memory, such as executing one or more computer programs for identifying potential chargebacks and reductions. Such processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 110, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

The analytical engine 110 is in communication with a database 112. The database stores information received from the various information systems 102-108. The database may also store historical analyses that can be used by the analytical engine 110 to analyze current data.

The analytical engine 110 generates a series of controls reports 114. The controls reports 114 may include internal controls data, such as errors and exceptions. These reports can be used to track duplicate invoices and payments, rebates, price protection practices, allowances, returned items, and cash and freight discounts. The reports may be provided as web-enabled reports that are available for online retrieval.

Some of the controls reports 114 may be provided to a vendor 116. The vendor 116 can then use the reports to collaborate with the organization to determine whether a chargeback or reduction is appropriate. For instance, the vendor 116 may dispute a particular chargeback and provide validating information to the organization in support of its position.

In conventional systems, exceptions are typically mailed to a vendor, and the vendor is given a certain number of days to respond. If they do not respond, a deduction is taken corresponding to an exception. In one embodiment of this invention, an email message is sent to the vendor. The vendor is given the ability to approve the reduction based on the exception or to dispute the reduction. In one such embodiment, the user is able to send a return email, attaching supporting documentation to the email. In another embodiment, the user is sent a uniform resource link (URL) to a portal from which the vendor can view information pertinent to the deduction and either approve or dispute the reduction. In another embodiment, a workflow process manages the approval or dispute of reductions. Once the approval or dispute process is complete, the reduction or chargeback is processed through the financial systems of the retailer.

The analytical engine 110 also produces metrics and performance indicators 118. The metrics and performance indicators 118 may be in the form of charts and graphs or in other forms. The metrics and performance indicators 118 may include, for example, cost management, productivity, cash management, and other tracking information. The information may be made available to a user through a client device (not shown).

The client device may comprise a processor and memory and may also comprise a number of external or internal devices such as a mouse, a CD-ROM, DVD, a keyboard, a display, or other input or output devices. Examples of such client devices are personal computers, digital assistants, personal digital assistants, cellular phones, mobile phones, smart phones, pagers, digital tablets, laptop computers, Internet appliances, and other processor-based devices. In general, a client device may be any type of suitable processor-based platform that is connected to a network or executing software directly and that interacts with one or more application programs. A client device may operate on any operating system capable of supporting an application. Such operating systems include Microsoft® Windows® and Linux. The client device may be, for example, a personal computer executing a browser application program such as Microsoft Corporation's Internet Explorer™, Netscape Communication Corporation's Netscape Navigator™, and Apple Computer, Inc.'s Safari™ or reporting and analysis applications, such as Cognos' PowerPlay online analytical processing tool and accessing database 112 to provide reports.

### Recovery Auditing

Embodiments of this invention allow for recovery auditing that occurs closer to the transaction than in conventional systems. Auditing closer to the transaction with technology helps the retailer fix the “deal capture” issue, fosters a continuous improvement environment, engenders stronger vendor relations, does not jeopardize promotional funds for the current year, and ultimately, allows the retailer to be more profitable.

Auditing closer to the transaction helps the vendor fix the underlying billing issues that caused funds to be missed, enables automated cash application, ensures the intent of the promotion matches the reality, flags discrepancies when all necessary documentation and staff are in place to resolve issues, fosters deeper vendor relationships, and does not expose vendors to the volatility of margin erosion long after financial periods are closed out.

Initially, implementing an embodiment of this invention will likely result in more chargebacks to the vendor, as retailers seek to move to current. In other words, to migrate from two years of retrospective audit to a real-time environment, the retailer needs to catch up on two years of un-reviewed transactions. Once retailers are working in a current mode, the chargebacks will drop fairly significantly, as errors will be flagged at the time of the transaction or shortly thereafter. Retailers will transfer existing staff resources to the data capture component, codifying deal sheets early on and mining email for deal commitments to be entered into their systems.

The retail post audit industry will change dramatically, as companies embrace technology and decrease their reliance on after-the-fact recovery audits. The process will be an evolution over the next two to four years, from “pure service” to a blended “service & technology” to primarily “technology.” When implementing an embodiment of this invention, it is not necessary to displace the current recovery audit provider. The primary auditor remains in place initially as a “safety net.” At some point, the retailer may be able to phase out the secondary auditor as the potential for incremental findings drops. The prevalence of errors also drops as processes are improved, but the depth of the review increases. As the largest recovery audit firms treat every engagement as a custom job, they do not perform the same depth of review for all retailers. It is more dependent now upon the skill of the assigned audit team versus a technology platform. The migration to technology will increase the scope of areas reviewed, and at a much deeper level than was possible with these “customized” audits. The findings will move from a “post audit” to a “pre-audit”, but will be significantly reduced.

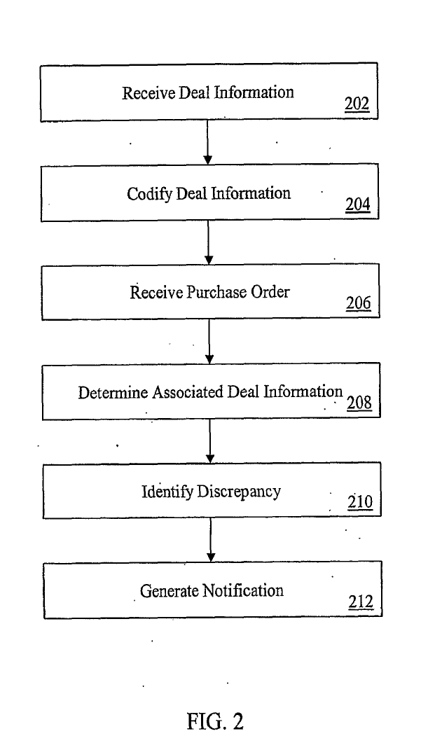

FIG. 2 is a flowchart illustrating a process an analytical engine may use to identify inconsistencies in one embodiment of this invention. In the embodiment shown, the analytical engine receives deal information 202. The deal information may be received from a manufacturer's system via an upload. The deal information may also or instead be mined from an email store, such as a Microsoft® Exchange server.

The analytical engine next codifies the deal information 202. For instance, the analytical engine may store the manufacturer and product identifier along with a discount amount, discount type, and effective dates in a structured data store. The process of receiving and codifying deal information may be done repetitively. Also, the receiving and codifying of deal information may occur on a periodic basis in a separate process in some embodiments of this invention.

The analytical engine next receives a purchase order 206. The purchase order may be received from a financial or merchandise system. The purchase order reflects a desire or plan to purchase a particular product from a particular manufacturer at a particular time.

The analytical engine utilizes the properties of the purchase order to determine deal information associated with the purchase order 208. For instance, a manufacturer may have agreed to provide a product at a ten percent discount for orders over 1000 items placed in a particular calendar month. If the purchase order is placed during the month in which the deal is effective and for a product identified in the deal, the purchase order should include the ten percent discount.

The analytical engine next identifies any discrepancies between the purchase order and the deal 210. For instance, if the ten percent discount should apply to a purchase order, but the discount is not reflected in the purchase order total, the analytical engine would identify the price difference as a discrepancy.

The analytical engine then quantifies the discrepancy and generates a notification 212. The notification may be received, for example, by a buyer, who can take immediate action. In this way, any issues are resolved when they occur rather than months—or even years—later. By identifying discrepancies when they occur, an embodiment of this invention helps to maintain good relationships with manufacturers and other vendors by not subjecting them to unpredictable financial impacts long after accounting periods are closed out.

By identifying discrepancies, an embodiment of this invention can also identify trends in purchasing. This information can be used to pinpoint exceptions that may warrant further investigation. In one embodiment, the analytical engine provides detailed and comprehensive management reporting of exceptions overtime.

### Deal Discovery

Embodiments of this invention provide automated deal discovery, including identifying undocumented deals and deals captured in unstructured data stores, such as an email server. Undocumented deals are deals that are offered on purchase orders, but have not been captured as deal commitments. Once flagged, the retailer can solicit the necessary deal documentation in real-time, when it is easily obtained. Thus, over time, a retailer requires fewer resources for the auditing component as the “false positives” of exceptions flagged drop through better technology. When an error occurs, it will be fixed at that time. In conventional systems, a billing error may continue to reoccur over numerous subsequent purchase orders for the same SKU, until a recovery audit identified the issue six to thirty-six months later. Although a retailer may continue to track all errors from an internal control perspective, in an embodiment of this invention, these errors are corrected on the underlying billing and payment systems (some prior to payment), minimizing after-the-fact chargebacks.

A high percentage of the deductions that occur are a result of poor data capture of deal parameters on the front end. In conventional systems, recovery audit firms typically access “raw” deal information, whether it is on paper deal sheets or buried in emails, and key them into a system. These “deal files” are then married back with the relevant purchasing and EDI billing information to flag exceptions.

Since these deals are typically handled via paper, they do not always get to the right people. Even if they do, most are hand-keyed, leading to input errors. And even if the deals get to the right person, they may be entered into the retailer's system after the effective start date. Accordingly, any purchase orders created after the deal start date but prior to the deal entry date will be incorrect. The corresponding purchase orders will therefore not reflect the deal, and even if the vendor bills it correctly, it will cause a mismatch from an error-handling standpoint. For the vendor, any payment received that contains a deduction likely halts automated cash application, making manual intervention necessary. To address this issue, in one embodiment of this invention, deals are uploaded into the retailers' systems from a vendor via a web connection, eliminating keying errors and ensuring that the retailer retains the deal reference numbers critical to vendors for proper accounting for promotional funds. Since this upload process is in place with many retailers for list prices, it can be readily modified to include deal information.

Capturing an error prior to the funds being released costs about 1/10^{th} of what it costs to recover monies from a vendor. A recent recovery audit survey conducted by Georgia State University quantified the cost of resolving a claim at about $375 per claim, so fewer claims means more profit to both the retailer and their vendors.

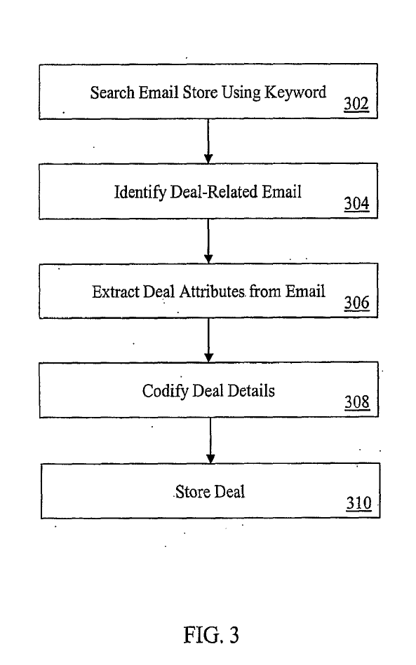

FIG. 3 is a flowchart illustrating a process for deal identification in one embodiment of this invention. In the embodiment shown, a processor executing software searches an email store for deal-related emails using a keyword 302. For instance, the algorithm may use variations of product names supplied to a retailer to identify emails with the product name in the subject or text of the email. Alternatively or in addition, the algorithm may search for particular domains from which the email was sent, such as the domain of a vendor.

The algorithm identifies deal-related emails 304. The emails identified in the email data store by keyword may or may not be deal related. For instance, an email regarding a product may be announcing a new feature or a lack of availability. Thus, the algorithm identifies emails within the set that satisfied the keyword criteria that are deal related. The algorithm may identify these emails by identifying parameters present in the email. For example, if the email includes text indicative of a deal, such as the product name, “price,” and “effective date,” the algorithm may identify the email as a deal-related email.

The algorithm next extracts deal attributes from the email 306. For instance, if the email includes the text “price,” the algorithm searches for an amount near the word price and sets the price attribute of the deal equal to the amount. A similar process occurs for each of the deal-related parameters.

The algorithm then uses the parameters to codify the deal 308. In order to compare the deals' to records, such as invoices and purchase orders, the deals are codified in a standard format. For instance, all of the deals may be placed in a database table in a database. The database table includes fields, such as SKU, price, start date, and end date. In this way, the deals can be effectively compared to the retailer's records of purchases and/or orders. The algorithm then stores the deals in a deal data store 310.

Embodiments such as these provide numerous advantages to the retailer and vendor. For instance, the retailers receive the money for the exception immediately and are able fix the error that caused the exception. For instance, if a wrong price is entered on a purchase order, and the error is fixed immediately, the next twenty-five purchase orders will be correct. If the error is not corrected, the purchase orders are going to have to be identified in a recovery audit after the money has already been released. In addition, by bringing the audit process in house, the retailer is able to exert increased organizational control, gain cost savings, at the very least a portion of the costs of multiple outside auditors, and realize continuous process improvement (being able to identify keying errors immediately and before they cause significant issues). The retailer is also able to gain a better understanding of profitability.

### Illustrative User Interface

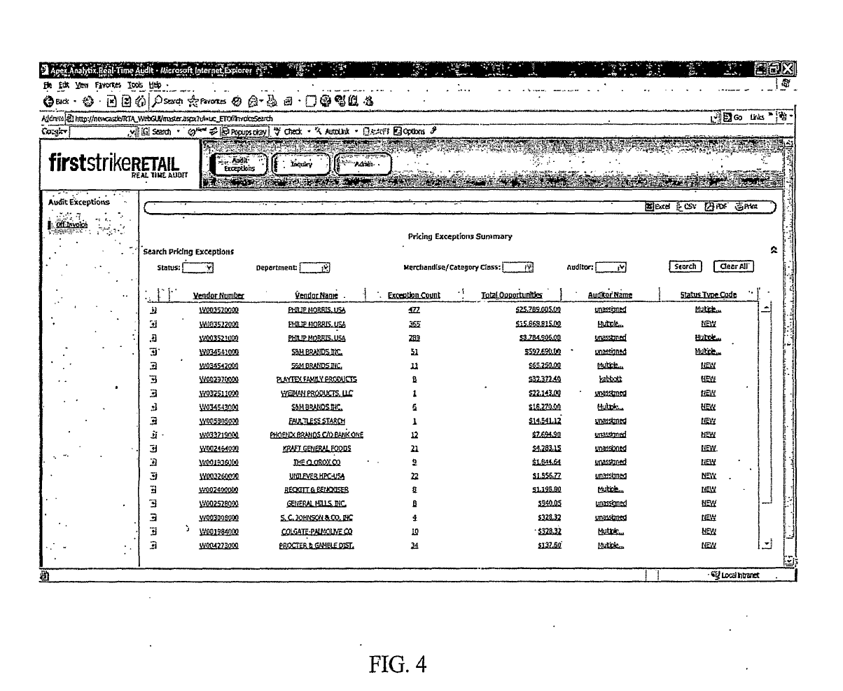

FIG. 4 is a screen shot of a screen for displaying an off-invoice summary in one embodiment of this invention. In the embodiment shown, a list of vendors is displayed. For each vendor, the number of exceptions identified and the total amount of these exceptions, which are referred to as opportunities, are displayed.

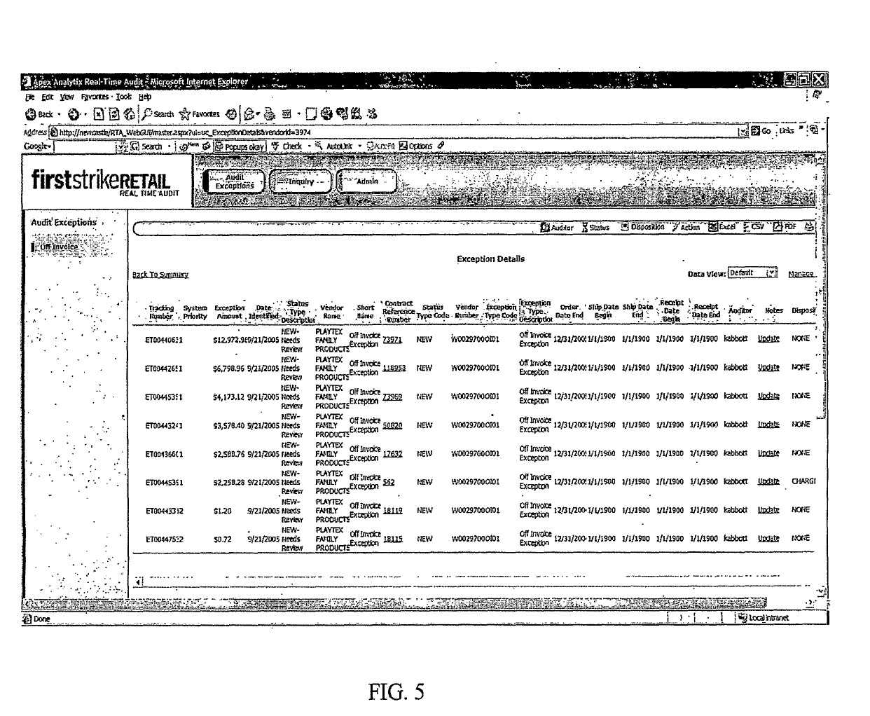

FIG. 5 is a screen shot of a screen for displaying off-invoice detail in one embodiment of this invention. The screen shown in FIG. 5 provides detail for a vendor selected from the summary screen shown in FIG. 4. In the embodiment shown, the screen provides details of the particular products associated with the exceptions, when the exceptions were identified, when the products were ordered, and additional information.

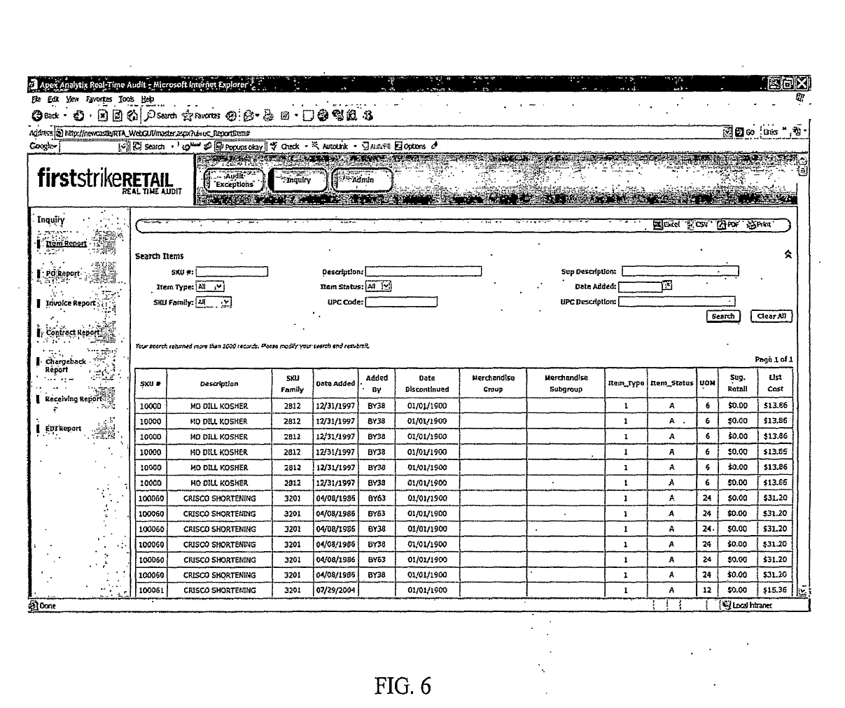

FIG. 6 is a screen shot of an item master inquiry screen in one embodiment of this invention. In the embodiment shown, the user inputs search criteria. In response, the screen provides particular items satisfying the query criteria and information about the particular items, such as list cost.

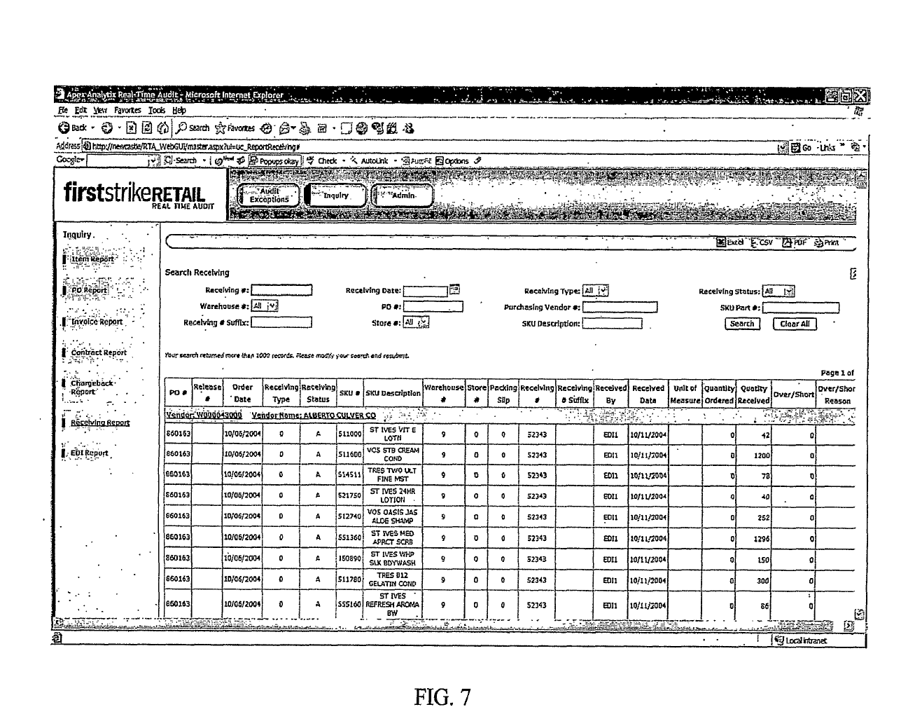

FIG. 7 is a screen shot of a receiving inquiry screen in on embodiment of this invention. This screen provides detail as to what was received and when it was received in relation to purchase orders for particular products.

In one embodiment of this invention, a portable document format (PDF) file is sent to a vendor. The PDF file includes a cover sheet that identifies the various exceptions that have been identified. The PDF file also includes detail of the exceptions by SKU and by invoice number. The PDF file may also include a scanned image of the deal between the retailer and the vendor. The email includes a mechanism for the vendor to approve or dispute the exception. In another embodiment, exception information is sent to the vendor via facsimile.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the this invention.

That which is claimed:

1. A method comprising:
receiving deal information;
receiving purchase order or payment information associated with the deal information;
identifying a discrepancy between the deal information and the purchase order or payment information; and
generating a notification identifying the discrepancy to enable automated exception reporting or retail recovery.

2. The method of claim 1, wherein receiving the deal information comprises:
receiving the deal information in a first format; and
codifying the deal information in a second format.

3. The method of claim 1, wherein the deal information is received from a manufacturer.

4. The method of claim 1, wherein receiving the deal information further comprises mining the deal information from a data store.

5. The method of claim 4, wherein the data store comprises an email data store.

6. The method of claim 5, wherein mining the deal information from the data store comprises searching the email data store for messages comprising a keyword.

7. The method of claim 6, wherein the keyword comprises one of “discount,” “price,” “effective date,” “volume,” a quantity, a lot description or a product name.

8. The method of claim 2, wherein codifying the deal information comprises storing a manufacturer identifier, an identifier, a discount amount, a discount type, and an effective date in a data store.

9. The method of claim 1, wherein the purchase order or payment is received from one of a financial system or a merchandise system.

10. The method of claim 1, wherein the notification comprises a control report.

11. The method of claim 1, wherein the notification comprises a chargeback or deduction to the vendor.

12. A computer-readable medium comprising executable program code, the computer-readable medium comprising:
program code for receiving deal information;
program code for receiving purchase order or payment information associated with the deal information;
program code for identifying a discrepancy between the deal information and the purchase order or payment information; and
program code for generating a notification identifying the discrepancy to enable automated exception reporting or retail recovery.

13. The computer-readable medium of claim 12, wherein receiving the deal information comprises:
program code for receiving the deal information in a first format; and
program code for codifying the deal information in a second format.

14. The computer-readable medium of claim 12, wherein program code for receiving the deal information further comprises program code for mining the deal information from a data store.

15. The computer-readable medium of claim 14, wherein the data store comprises an email data store.

16. The computer-readable medium of claim 15, wherein program code for mining the deal information from the data store comprises program code for searching the email data store for messages comprising a keyword.

17. The computer-readable medium of claim 12, wherein program code for codifying the deal information comprises program code for storing a manufacturer identifier, an identifier, a discount amount, a discount type, and an effective date in a data store.

18. A system comprising:
a data store having:
deal information in a first format, and
purchase order or payment information associated with the deal information; and
an analytical engine in communication with the financial system, the analytical engine configured to:
receive the deal information from the data store;
receive the purchase order or payment information from the data store;
identify a discrepancy between the deal information and the purchase order or payment information, and
generate a notification identifying the discrepancy to enable automated retail recovery.

19. The system of claim 18, wherein the analytical engine is further configured to mine the deal information from the data store.

20. The method of claim 19, wherein the data store comprises an email data store.
